(19) United States
(12) Patent Application Publication
(10) Pub. No.: US 2008/0174583 A1
(43) Pub. Date: Jul. 24, 2008

(54) COMPENSATING FEED-THROUGH VOLTAGE DISPLAY DEVICE

(75) Inventors: Kun-Chen Lee, Tainan County (TW); Chia-Hua Yu, Taipei County (TW); Sung-Chun Lin, Taichung County (TW); Min-Hsiang Hong, Tainan City (TW); Hui-Fang Cheng, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HANNSTAR DISPLAY CORP., Tao-Yuan Hsien (TW)

(21) Appl. No.: 11/625,362

(22) Filed: Jan. 22, 2007

(51) Int. Cl. G09G 5/00

(52) U.S. Cl. 345/211

(57) ABSTRACT

A compensating feed-through voltage display device comprises a first gamma circuit, a second gamma circuit, a first driving circuit and a second driving circuit. The first gamma circuit generates first group gamma voltages. The second gamma circuit generates second group gamma voltages differing from the first group gamma voltages by a preset first voltage. The first driving circuit transmits a plurality of first data signals to a display array according to the first group gamma voltages and a first control signal. The second driving circuit transmits a plurality of second data signals to the display array according to the second group gamma voltages and a second control signal.

### BACKGROUND OF THE INVENTION

1. Field of the Invention

The invention relates to a compensating feed-through voltage display device, and in particular to a circuit shifting a plurality of data signals by a voltage level to reduce flicker.

2. Description of the Related Art

FIG. 1 shows a conventional TFT LCD (Thin-Film Transistor Liquid Crystal Display) device 100. TFT LCD 100 comprises source driving circuit 110, gate driving circuit 120 and display array 130. Display array 130 comprises a plurality of display units. For simplicity, FIG. 1 only illustrates display unit 141 comprising driving transistor 142, storage capacitor 143 and light emitting unit 144. Storage capacitor 143 and light emitting unit 144 are coupled to common voltage V_{com}. Since each display unit of display array 130 has a different feed-through voltage based on the position thereof, each display unit needs different common voltages. FIG. 2 shows a relationship between the optimum common voltage and the display unit position. Referring to FIG. 1, based on measurement of a normal display array, the optimum common voltage V₁ at A area of display array 130 is often less than the optimum common voltage V₂ at B area of display array 130 and the optimum common voltage V₂ at B area of display array 130 is often less than the optimum common voltage V₃ at C area of display array 130, as shown in FIG. 2. If TFT LCD 100 provides only one common voltage to each display unit of display array 130, the image of display array 130 flickers.

### BRIEF SUMMARY OF THE INVENTION

A detailed description is given in the following embodiments with reference to the accompanying drawings.

A compensating feed-through voltage display device comprises a first gamma circuit generating first group gamma voltages, a second gamma circuit generating second group gamma voltages differing from the first group gamma voltages by a preset first voltage, a first driving circuit transmitting a plurality of first data signals to a display array according to the first group gamma voltages and a first control signal and a second driving circuit transmitting a plurality of second data signals to the display array according to the second group gamma voltages and a second control signal.

A compensating feed-through voltage display device comprises a first gamma circuit generating first group gamma voltages, a first level shift circuit shifting the first group gamma voltages by a preset first voltage to generate second group gamma voltages, a first driving circuit transmitting a plurality of first data signals to a display array according to the first group gamma voltages and a first control signal and a second driving circuit transmitting a plurality of second data signals to the display array according to the second group gamma voltages and a second control signal.

### BRIEF DESCRIPTION OF THE DRAWINGS

The invention can be more fully understood by reading the subsequent detailed description and examples with references made to the accompanying drawings, wherein:

FIG. 1 shows a conventional TFT LCD device;

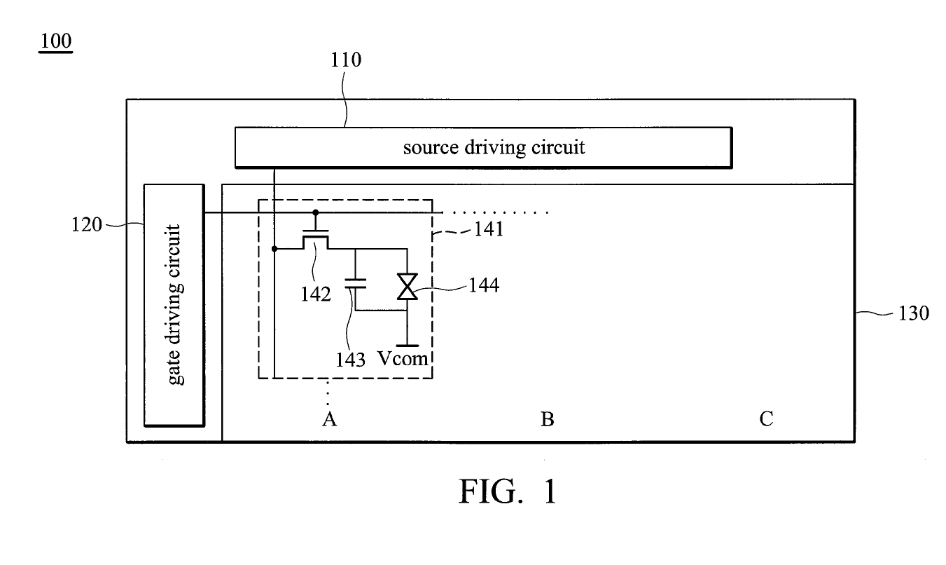

FIG. 2 shows a relationship between the optimum common voltage and the display unit position;

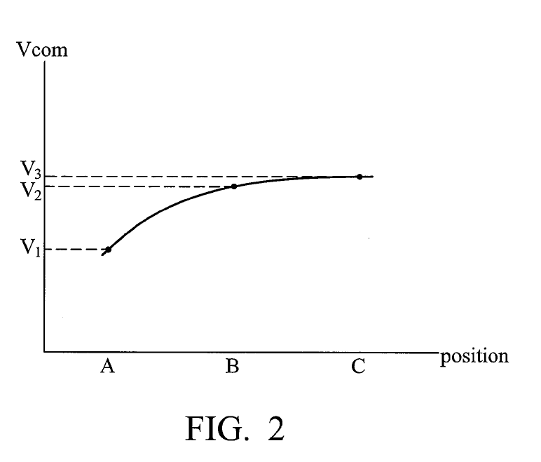

FIG. 3 shows a compensating feed-through voltage display device according to an embodiment of the invention; and

FIG. 4 shows a compensating feed-through voltage display device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

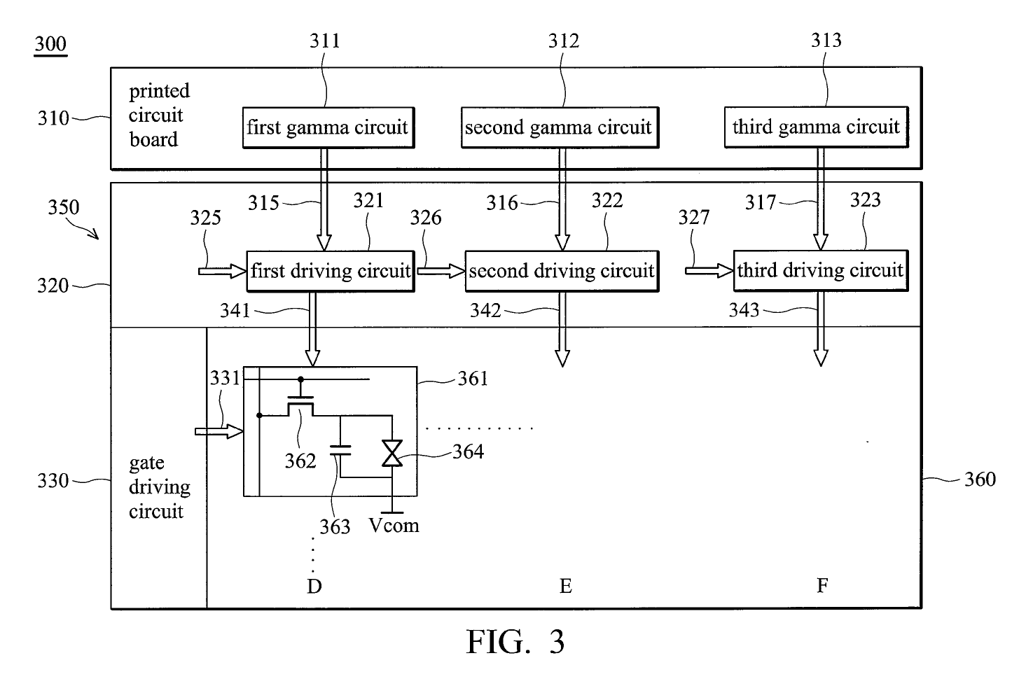

FIG. 3 shows a compensating feed-through voltage display device 300 according to an embodiment of the invention. Since each display unit of display array 360 at different positions has a different feed-through voltage, common voltages of display units of display array 360 in different positions are different, such that flicker may occur. According to the invention, compensating feed-through voltage display device 300 shifts data signals by a voltage level to reduce image flicker.

Compensating feed-through voltage display device 300 comprises printed circuit board 310 and panel 350. Printed circuit board 310 comprises first gamma circuit 311, second gamma circuit 312 and third gamma circuit 313. Panel 350 comprises source driving circuit 320, gate driving circuit 330 and display array 360. Display array 360 comprises a plurality of display units. For simplicity, FIG. 3 illustrates only display unit 361 comprising driving transistor 362, storage capacitor 363 and light emitting unit 364. Storage capacitor 363 and light emitting unit 364 are coupled to common voltage V_{com}. Source driving circuit 320 provides a plurality of data signals to display units of display array 360. Source driving circuit 320 comprises first driving circuit 321, second driving circuit 322 and third driving circuit 323. First gamma circuit 311 generates first group gamma voltages 315 to first driving circuit 321 which generates a plurality of first data signals 341 to the display units at D area of display array 360. Second gamma circuit 312 generates second group gamma voltages to second driving circuit 322. A first preset voltage drop occurs between first group gamma voltages and second group gamma voltage. Second driving circuit 322 transmits a plurality of second data signals 342 to the display units at E area of display array according to second control signals 326 and second group gamma voltages 316. Third gamma circuit 313 generates third gamma group voltages 317 to third driving circuit 323. A second preset voltage drop occurs between first group gamma voltages and third group gamma voltage. Third driving circuit 323 transmits third data signals 343 to the display units at F area of display array 360 according to third control signals 327 and third group gamma voltages 317. Each display unit of display array 360 emits light according to first data signals 341, second data signals 342, third data signals 343 and scan signals 331. In addition, the first preset voltage drop is a common voltage drop |V₂-V₁| between D area and E area of display array 360 and the second preset drop is a common voltage drop |V₃-V₁| between D area and F area of display array 360.

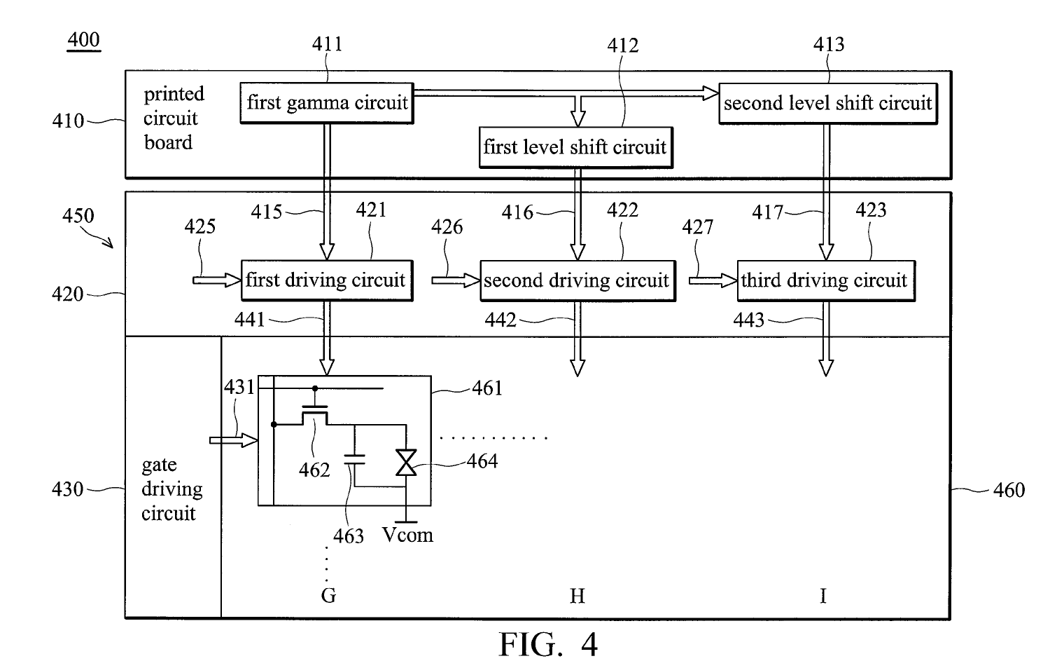

FIG. 4 shows compensating feed-through voltage display device 400 according to another embodiment of the invention. Compensating feed-through voltage display device 400 comprises printed circuit board 410 and panel 450. Printed circuit board 410 comprises first gamma circuit 411, first level shift circuit 412 and second level shift circuit 413. Panel 450 comprises source driving circuit 420, gate driving circuit 430 and display array 460, comprising a plurality of display units. Gate driving circuit 430 provides a plurality of scan signals 431 to display units of display array 460. FIG. 4 illustrates only display unit 461 comprising driving transistor 462, storage capacitor 463 and light emitting unit 464. Storage capacitor 463 and light emitting unit 464 are coupled to common voltage V_{com}. Source driving circuit 420 provides a plurality of data signals to display units of display array 460. Source driving circuit 420 comprises first driving circuit 421, second driving circuit 422 and third driving circuit 423. First gamma circuit 411 generates first group gamma voltages 415 to first driving circuit 421. First driving circuit 421 transmits a plurality of first data signals 441 to the display units at G area of display area 460 according to first control signals 425. First level shift circuit 421 shifts first group gamma voltages 415 by the first preset voltage to generate second group gamma voltages 416 to second driving circuit 422. Second driving circuit 422 transmits a plurality of second data signals 442 to the display units at H area of display area 460 according to second control signals 426 and second group gamma voltages 416. Second level shift circuit 413 shifts first group gamma voltages 415 by the second preset voltage to generate third group gamma voltages 417 to third driving circuit 423. Third driving circuit 423 transmits a plurality of third data signals 443 to the display units at I area of display area 460 according to third control signals 427 and third group gamma voltages 417. Each display unit of display array 460 emits light according to first data signals 441, second data signals 442, third data signals 443 and scan signals 431.

Using FIG. 3 as an example, with common voltage V_{com} 6.5V, and first group gamma voltages, second group gamma voltages and third group gamma voltages between 0.5V and 12.5V, since each display unit of display array 360 in different positions has different feed-through voltage, feed-through voltage at D area ΔP₁ is the largest, feed-through voltage at E area ΔP₂ is the middle, and feed-through voltage at F area ΔP₃ is the smallest. If feed-through voltage at D area ΔP₁ is 1.5V, feed-through voltage at E area ΔP₂ is 1.3V and feed-through voltage at F area ΔP₃ is 1.2V, the optimum common voltage at D area is 5V, the optimum common voltage at E area is 5.2V and the optimum common voltage at F area is 5.3V. If the common voltage of each display unit of display array 360 is 5V, first group gamma voltages are still between 0.5V and 12.5V. Since the feed-through voltage in different positions is different, the second group gamma voltage is adjusted between 0.3V and 12.3V and the third group gamma voltage is adjusted between 0.2V and 12.2V. The voltage drop between the first group gamma voltages and the second group gamma voltage is 0.2V and the voltage drop between the first group gamma voltages and the third group gamma voltage is 0.3V. Using FIG. 4 as an example with the initial condition the same as the previous condition, feed-through voltage at G area ΔP₄ is 1.5V, feed-through voltage at II area ΔP₅ is 1.3V and feed-through voltage at I area ΔP₆ is 1.2V. First level shift circuit 412 shifts first group gamma voltages 0.2V to generate second group gamma voltages. Second level shift circuit 413 shifts the first group gamma voltages 0.3V to generate the third group gamma voltages. Thus, the voltage drops between each display unit, reducing image flicker.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A compensating feed-through voltage display device, comprising:
a first gamma circuit for generating first group gamma voltages;
a second gamma circuit for generating second group gamma voltages differing from the first group gamma voltages by a preset first voltage;
a first driving circuit for transmitting a plurality of first data signals to a display array according to the first group gamma voltages and a first control signal; and
a second driving circuit for transmitting a plurality of second data signals to the display array according to the second group gamma voltages and a second control signal.

2. The compensating feed-through voltage display device as claimed in claim 1 further comprising:
a printed circuit board comprising the first gamma circuit and the second gamma circuit; and
a panel comprising:
a source driving circuit comprising the first driving circuit and the second driving circuit to provide the first data signals and the second data signals to the display array; and
a gate driving circuit for providing a plurality of scan signals to the display array.

3. The compensating feed-through voltage display device as claimed in claim 2, wherein the display array comprises a plurality of display units.

4. The compensating feed-through voltage display device as claimed in claim 3, wherein the display units emit light according to the first data signals, the second data signals and the scan signals, and the display units are coupled to a common electrode.

5. The compensating feed-through voltage display device as claimed in claim 1 further comprising:
a third gamma circuit for generating third group gamma voltages differing from the first gamma voltages by a preset second voltage; and
a third driving circuit for transmitting a plurality of third data signals to the display array according to the third group gamma voltages and a third control signal.

6. The compensating feed-through voltage display device as claimed in claim 5, wherein the first driving circuit provides the first data signals to a first part of the display array, the second driving circuit provides the second data signals to a second part of the display array and the third driving circuit provides the third data signals to a third part of the display array.

7. The compensating feed-through voltage display device as claimed in claim 2, wherein the source driving circuit further comprises a third driving circuit to provide a plurality of third data signals to the display array.

8. A compensating feed-through voltage display device, comprising:
a first gamma circuit for generating first group gamma voltages;
a first level shift circuit for shifting the first group gamma voltages by a preset first voltage to generate second group gamma voltages;
a first driving circuit for transmitting a plurality of first data signals to a display array according to the first group gamma voltages and a first control signal; and
a second driving circuit for transmitting a plurality of second data signals to the display array according to the second group gamma voltages and a second control signal.

9. The compensating feed-through voltage display device as claimed in claim 8 further comprising:
a printed circuit board comprising the first gamma circuit and the first shift circuit; and
a panel comprising:
a source driving circuit comprising the first driving circuit and the second driving circuit to provide the first data signals and the second data signals to the display array; and
a gate driving circuit providing a plurality of scan signals to the display array.

10. The compensating feed-through voltage display device as claimed in claim 9, wherein the display array comprises a plurality of display units.

11. The compensating feed-through voltage display device as claimed in claim 10, wherein the display units emit light according to the first data signals, the second data signals and the scan signals and the display units are coupled to a common electrode.

12. The compensating feed-through voltage display device as claimed in claim 8 further comprising:
a second level shift circuit shifting the first group gamma voltages by a preset second voltage to generate third group gamma voltages; and
a third driving circuit transmitting a plurality of third data signals to the display array according to the third group gamma voltages and a third control signal.

13. The compensating feed-through voltage display device as claimed in claim 12, wherein the first driving circuit provides the first data signals to a first part of the display array, the second driving circuit provides the second data signals to a second part of the display array and the third driving circuit provides the third data signals to a third part of the display array.

14. The compensating feed-through voltage display device as claimed in claim 9, wherein the source driving circuit further comprises a third driving circuit to provide a plurality of third data signals to the display array.

15. A driving method of a display device having a display array, comprising:
generating first group gamma voltages;
generating second group gamma voltages differing from the first group gamma voltages by a preset first voltage;
transmitting a plurality of first data signals to the display array according to the first group gamma voltages and a first control signal; and
transmitting a plurality of second data signals to the display array according to the second group gamma voltages and a second control signal.

16. The method as claimed in claim 1 further comprising:
generating third group gamma voltages differing from the first gamma voltages by a preset second voltage; and
transmitting a plurality of third data signals to the display array according to the third group gamma voltages and a third control signal.

17. The method as claimed in claim 16, wherein the first data signals are transmitted to a first part of the display array, the second data signals are transmitted to a second part of the display array and the third data signals are transmitted to a third part of the display array.

18. The method as claimed in claim 17, wherein the display device further display array comprises a plurality of display units, and the display units emit light according to the first data signals, the second data signals and the scan signals, and the display units are coupled to a common electrode.

19. A driving method of a display device having a display array, comprising:
generating first group gamma voltages;
shifting the first group gamma voltages by a preset first voltage to generate second group gamma voltages;
transmitting a plurality of first data signals to a display array according to the first group gamma voltages and a first control signal; and
transmitting a plurality of second data signals to the display array according to the second group gamma voltages and a second control signal.

20. The method as claimed in claim 19, wherein the display array comprises a plurality of display units, and the display units emit light according to the first data signals, the second data signals and the scan signals and the display units are coupled to a common electrode.

21. The method as claimed in claim 19 further comprising:
shifting the first group gamma voltages by a preset second voltage to generate third group gamma voltages; and
transmitting a plurality of third data signals to the display array according to the third group gamma voltages and a third control signal.

22. The method as claimed in claim 21, wherein the first data signals are transmitted to a first part of the display array, the second data signals are transmitted to a second part of the display array and the third data signals are transmitted to a third part of the display array.
